(19) United States
(12) Patent Application Publication
(10) Pub. No.: US 2017/0193041 A1
(43) Pub. Date: Jul. 6, 2017

(54) Document-partitioned secondary indexes in a sorted, distributed key/value data store

(71) Applicant: Sqrrl Data, Inc., Cambridge, MA (US)

(72) Inventor: Adam P. Fuchs, Arlington, MA (US)

(21) Appl. No.: 14/988,489

(22) Filed: Jan. 5, 2016

(51) Int. Cl. G06F 17/30

(52) U.S. Cl. CPC G06F 17/30442; G06F 17/30333; G06F 17/30477; G06F 17/30289; G06F 17/30902; G06F 17/30867

(57) ABSTRACT

A method and apparatus are operative in association with a table in a sorted, distributed key-value primary store. The table has associated therewith one or more tablets, wherein each tablet being a partition of the table and that contains key-value pairs in a given sub-range of keys. According to the method, a secondary index that is adapted to optimize particular search and query operations against the primary store is created. The secondary index is stored in a manner such secondary index entries are co-partitioned with entries of the primary store to which the secondary index entries refer. This co-partitioning of the secondary index is then maintained throughout various tablet lifecycle operations (e.g., ingest, minor compaction, major compaction, scan, split and merge) associated with at least one tablet. An information retrieval system may leverage the secondary indexing scheme together with query processing to find and retrieve documents matching a user's query.

### BACKGROUND

Technical Field

This application relates generally to secure, large-scale data storage and, in particular, to database systems providing fine-grained access control.

Brief Description of the Related Art

“Big Data” is the term used for a collection of data sets so large and complex that it becomes difficult to process (e.g., capture, store, search, transfer, analyze, visualize, etc.) using on-hand database management tools or traditional data processing applications. Such data sets, typically on the order of terabytes and petabytes, are generated by many different types of processes.

Big Data has received a great amount of attention over the last few years. Much of the promise of Big Data can be summarized by what is often referred to as the five V's: volume, variety, velocity, value and veracity. Volume refers to processing petabytes of data with low administrative overhead and complexity. Variety refers to leveraging flexible schemas to handle unstructured and semi-structured data in addition to structured data. Velocity refers to conducting real-time analytics and ingesting streaming data feeds in addition to batch processing. Value refers to using commodity hardware instead of expensive specialized appliances. Veracity refers to leveraging data from a variety of domains, some of which may have unknown provenance. Apache Hadoop™ is a widely-adopted Big Data solution that enables users to take advantage of these characteristics. The Apache Hadoop framework allows for the distributed processing of Big Data across clusters of computers using simple programming models. It is designed to scale up from single servers to thousands of machines, each offering local computation and storage. The Hadoop Distributed File System (HDFS) is a module within the larger Hadoop project and provides high-throughput access to application data. HDFS has become a mainstream solution for thousands of organizations that use it as a warehouse for very large amounts of unstructured and semi-structured data.

In 2008, when the National Security Agency (NSA) began searching for an operational data store that could meet its growing data challenges, it designed and built a database solution on top of HDFS that could address these needs. That solution, known as Accumulo, is a sorted, distributed key/value store largely based on Google's Bigtable design. In 2011, NSA open sourced Accumulo, and it became an Apache Foundation project in 2012. Apache Accumulo is within a category of databases referred to as NoSQL databases, which are distinguished by their flexible schemas that accommodate semi-structured and unstructured data. They are distributed to scale well horizontally, and they are not constrained by the data organization implicit in the SQL query language. Compared to other NoSQL databases, Apache Accumulo has several advantages. It provides fine-grained security controls, or the ability to tag data with security labels at an atomic cell level. This feature enables users to ingest data with diverse security requirements into a single platform. It also simplifies application development by pushing security down to the data-level. Accumulo has a proven ability to scale in a stable manner to tens of petabytes and thousands of nodes on a single instance of the software. It also provides a server-side mechanism (Iterators) that provide flexibility to conduct a wide variety of different types of analytical functions. Accumulo can easily adapt to a wide variety of different data types, use cases, and query types. While organizations are storing Big Data in HDFS, and while great strides have been made to make that data searchable, many of these organizations are still struggling to build secure, real-time applications on top of Big Data. Today, numerous Federal agencies and companies use Accumulo.

While technologies such as Accumulo provide scalable and reliable mechanisms for storing and querying Big Data, there remains a need to provide enhanced enterprise-based solutions that seamlessly but securely integrate with existing enterprise authentication and authorization systems, and that enable the enforcement of internal information security policies during database access.

### BRIEF SUMMARY

This disclosure describes a method and apparatus operative in association with a table in a sorted, distributed key-value primary store. The table has associated therewith one or more tablets, wherein each tablet being a partition of the table and that contains key-value pairs in a given sub-range of keys. According to the method, a secondary index that is adapted to optimize particular search and query operations against the primary store is created. The secondary index is stored in a manner such secondary index entries are co-partitioned with entries of the primary store to which the secondary index entries refer. This co-partitioning of the secondary index is then maintained throughout various tablet lifecycle operations (e.g., ingest, minor compaction, major compaction, scan, split and merge) associated with at least one tablet. The type of secondary index may be varied and may be one-dimensional (e.g., inverted full-text, B-trees, binary search trees, etc.) and multi-dimensional indexes.

According to another aspect, an information retrieval system is provided that leverages the above-described secondary indexing scheme together with query processing to find and retrieve documents matching a user's query.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 depicts the technology architecture for an enterprise-based NoSQL database system according to this disclosure;

FIG. 2 depicts the architecture in FIG. 1 in an enterprise to provide identity and access management integration according to this disclosure;

FIG. 3 depicts the main components of the solution shown in FIG. 2;

FIG. 4 illustrates a first use case wherein a query includes specified data-centric labels;

FIG. 5 illustrates a second use wherein a query does not include specified data-centric labels;

FIG. 6 illustrates a basic operation of the security policy engine;

FIG. 7 illustrates an ordinary tablet data flow for a key/value data store such as Accumulo;

FIG. 8 illustrates an augmented tablet data flow for a key/value data store that supports secondary indexes according to this disclosure;

FIG. 9 illustrates a tablet server that is augmented to provide the secondary index support according to this disclosure;

FIG. 10 illustrates how a document-partitioned index is used to support a table with secondary indexes;

FIG. 11 illustrates an example table in a key/value data store;

FIG. 12 illustrates a modified version of the table that includes inverted index entries;

FIG. 13 illustrates a first tablet having a secondary index and that results from applying a split operation to the table in FIG. 12; and

FIG. 14 illustrates a second tablet having a secondary index and that results from the split of the table in FIG. 12.

### DETAILED DESCRIPTION

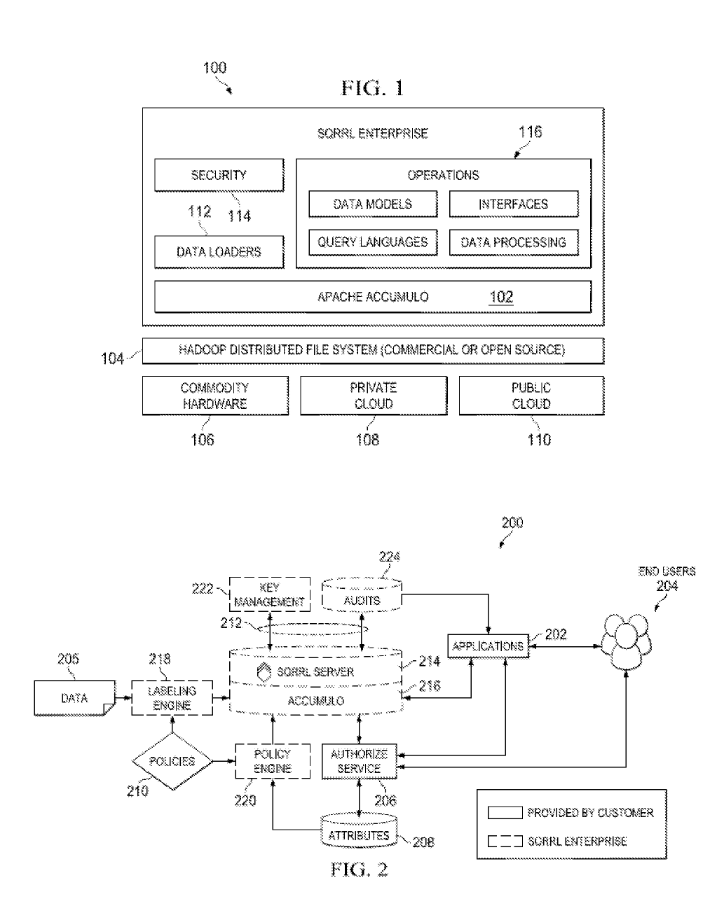

FIG. 1 represents the technology architecture for an enterprise-based database system of this disclosure. As will be described, the system 100 of this disclosure preferably comprises a set of components that sit on top of a NoSQL database, preferably Apache Accumulo 102. The system 100 (together with Accumulo) overlays a distributed file system 104, such as Hadoop Distributed File System (HDFS), which in turn executes in one or more distributed computing environments, illustrated by commodity hardware 106, private cloud 108 and public cloud 110. Sgrrl™ is a trademark of Sqrrl Data, Inc., the assignee of this application. Generalizing, the bottom layer typically is implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). A cloud platform may comprise co-located hardware and software resources, or resources that are physically, logically, virtually and/or geographically distinct. Communication networks used to communicate to and from the platform services may be packet-based, non-packet based, and secure or non-secure, or some combination thereof.

Referring back to FIG. 1, the system components comprise a data loader component 112, a security component 114, and an analytics component 116. Generally, the data loader component 112 provides integration with a data ingest service, such as Apache Flume, to enable the system to ingest streaming data feeds, such as log files. The data loader 112 can also bulk load JSON, CSV, and other file formats. The security component 114 provides data-centric security at the cell-level (i.e., each individual key/value pair is tagged with a security level). As will be described in more detail below, the security component 114 provides a labeling engine that automates the tagging of key/value pairs with security labels, preferably using policy-based heuristics that are derived from an organization's existing information security policies, and that are loaded into the labeling engine to apply security labels at ingest time. The security component 114 also provides a policy engine that enables both role-based and attribute-based access controls. As will also be described, the policy engine in the security component 114 allows the organization to transform identity and environmental attributes into policy rules that dictate who can access certain types of data. The security component 114 also integrates with enterprise authentication and authorization systems, such as Active Directory, LDAP and the like. The analytics component 116 enables the organization to build a variety of analytical applications and to plug existing applications and tools into the system. The analytics component 116 preferably supports a variety of query languages (e.g., Lucene, custom SQL, and the like), as well as a variety of data models that enable the storage of data as key/value pairs (native Accumulo data format), as graph data, and as JavaScript Object Notation (JSON) data. The analytics component 116 also provides an application programming interface (API), e.g., through Apache Thrift. The component 116 also provides real-time processing capabilities powered by iterators (Accumulo's native server-side mechanism), and an extensible indexing framework that indexes data upon.

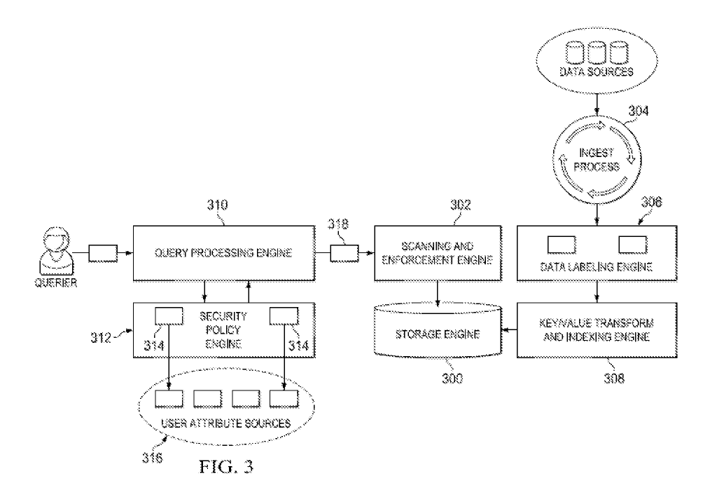

FIG. 2 depicts the architecture in FIG. 1 integrated in an enterprise to provide identity and access management according to an embodiment of this disclosure. In this embodiment, it is assumed that the enterprise 200 provides one or more operational applications 202 to enterprise end users 204. An enterprise service 206 (e.g., Active Directory, LDAP, or the like) provides identity-based authentication and/or authorization in a known manner with respect to end user attributes 208 stored in attributed database. The enterprise has a set of information security policies 210. To provide identity and access management integration, the system 212 comprises server 214 and NoSQL database 216, labeling engine 218, and policy engine 220. The system may also include a key management module 222, and an audit sub-system 224 for logging. The NoSQL database 216, preferably Apache Accumulo, comprises an internal architecture (not shown) comprising tablets, tablet servers, and other mechanisms. The reader's familiarity with Apache Accumulo is presumed. As is well-known, tablets provide partitions of tables, where tables consist of collections of sorted key-value pairs. Tablet servers manage the tablets and, in particular, by receiving writes from clients, persisting writes to a write-ahead log, sorting new key-value pairs in memory, periodically flushing sorted key-value pairs to new files in HDFS, and responding to reads from clients. During a read, a tablet server provides a merge-sorted view of all keys and values from the files it created and the sorted in-memory store. The tablet mechanism in Accumulo simultaneously optimizes for low latency between random writes and sorted reads (real-time query support) and efficient use of disk-based storage. This optimization is accomplished through a mechanism in which data is first buffered and sorted in memory and later flushed and merged through a series of background compaction operations. Within each tablet a server-side programming framework (called the Iterator Framework) provides user-defined programs (Iterators) that are placed in different stages of the database pipeline, and that allow users to modify data as it flows through Accumulo. Iterators can be used to drive a number of real-time operations, such as filtering, counts and aggregations.

The Accumulo database provides a sorted, distributed key-value data store in which keys comprises a five (5)-tuple structure: row (controls atomicity), column family (controls locality), column qualifier (controls uniqueness), visibility label (controls access), and timestamp (controls versioning). Values associated with the keys can be text, numbers, images, video, or audio files. Visibility labels are generated by translating an organization's existing data security and information sharing policies into Boolean expressions over data attributes. In Accumulo, a key-value pair may have its own security label that is stored under the column visibility element of the key and that, when present, is used to determine whether a given user meets security requirements to read the value. This cell-level security approach enables data of various security levels to be stored within the same row and users of varying degrees of access to query the same table, while preserving data confidentiality. Typically, these labels consist of a set of user-defined labels that are required to read the value the label is associated with. The set of labels required can be specified using syntax that supports logical combinations and nesting. When clients attempt to read data, any security labels present in a cell are examined against a set of authorizations passed by the client code and vetted by the security framework. Interaction with Accumulo may take place through a query layer that is implemented via a Java API. A typical query layer is provided as a web service (e.g., using Apache Tomcat).

Referring back to FIG. 2, and according to this disclosure, the labeling engine 218 automates the tagging of key-value pairs with security labels, e.g., using policy-based heuristics. As will be described in more detail below, these labeling heuristics preferably are derived from an organization's existing information security policies 210, and they are loaded into the labeling engine 218 to apply security labels, preferably at the time of ingest of the data 205. For example, a labeling heuristic could require that any piece of data in the format of “xxx-xx-xxxx” receive a specific type of security label (e.g., “ssn”). The policy engine 220, as will be described in more detail below as well, provides both role-based and attribute-based access controls. The policy engine 220 enables the enterprise to transform identity and environmental attributes into policy rules that dictate who can access certain types of data. For example, the policy engine could support a rule that data tagged with a certain data-centric label can only be accessed by current employees during the hours of 9-5 and who are located within the United States. Another rule could support a rule that only employees who work for HR and who have passed a sensitivity training class can access certain data. Of course, the nature and details of the rule(s) are not a limitation.

The process for applying these security labels to the data and connecting the labels to a user's designated authorizations is now described. The first step is gathering the organization's information security policies and dissecting them into data-centric and user-centric components. As data 205 is ingested, the labeling engine 218 tags individual key-value pairs with data-centric visibility labels that are preferably based on these policies. Data is then stored in the database 216, where it is available for real-time queries by the operational application(s) 202. End users 204 are authenticated and authorized to access underlying data based on their defined attributes. For example, as an end user 204 performs an operation (e.g., performs a search) via the application 202, the security label on each candidate key-value pair is checked against the set of one or more data-centric labels derived from the user-centric attributes 208, and only the data that he or she is authorized to see is returned.

FIG. 3 depicts the main components of the solution shown in FIG. 2. As illustrated, the NoSQL database (located in the center) comprises a storage engine 300, and a scanning and enforcement engine 302. In this depiction, the ingest operations are located on the right side and comprise ingest process 304, data labeling engine 306, and a key-value transform and indexing engine 308. The left portion of the diagram shows the query layer, which comprises a query processing engine 310 and the security policy engine 312. The query processing engine 310 is implemented in the server in FIG. 2. As described above, as data is ingested into the server, individual key-value pairs are tagged with a data-centric access control and, in particular, a data-centric visibility label preferably based on or derived from a security policy. These key-value pairs are then stored in physical storage in a known manner by the storage engine 300.

At query time, and in response to receipt of a query from a querier, the query processing engine 310 calls out to the security policy engine 312 to determine an appropriate set of data-centric labels to allow the query to use if the query is to be passed onto the Accumulo database for actual evaluation. The query received by the query processing engine may include a set of one or more data-centric labels specified by the querier, or the query may not have specified data-centric labels associated therewith. Typically, the query originates from a human at a shell command prompt, or it may represent one or more actions of a human conveyed by an application on the human's behalf. Thus, as used herein, a querier is a user, an application associated with a user, or some program or process. According to this disclosure, the security policy engine 312 supports one or more pluggable policies 314 that are generated from information security policies in the organization. When the query processing engine 310 receives the query (with or without the data-centric labels), it calls out to the security policy engine to obtain an appropriate set of data-centric labels to include with the query (assuming it will be passed), based on these one or more policies 314. As further illustrated in FIG. 3, during this call-out process, the security policy engine 312 in turn may consult with any number of sources 316 for values of user-centric attributes about the user, based on the one or more pluggable policies 312 supported by the security policy engine. If the query is permitted (by the query processing engine) to proceed, the query 318 (together with the one or more data-centric labels) then is provided by the query processing engine 310 to the scanning and enforcement engine 302 in the NoSQL database. The scanning and enforcement engine 302 then evaluates the set of one or more data-centric labels in the query against one or more data-centric access controls (the visibility labels) to determine whether read access to a particular piece of information in the database is permitted. This key-value access mechanism (provided by the scanning and enforcement engine 302) is a conventional operation.

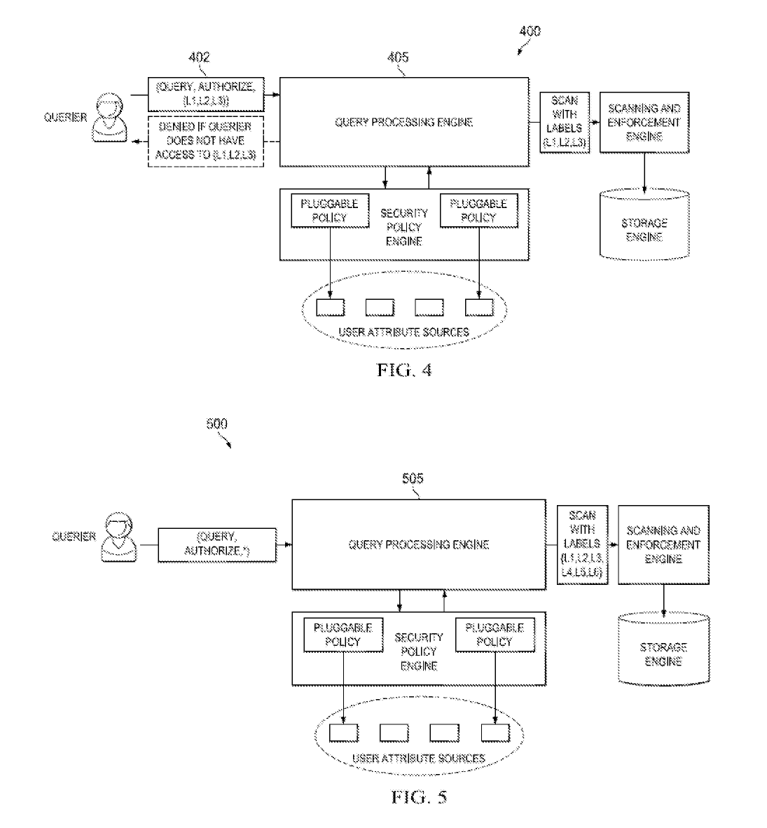

The query processing engine typically operates in one of two use modes. In one use case, shown in FIG. 4, the query 400 (received by the query processing engine) includes one or more specified data-centric labels 402 that the querier would like to use (in this example, L1-L3). Based on the configured policy or policies, the query processing engine 405 determines that the query may proceed with this set (or perhaps some narrower set) of data-centric labels, and thus the query is passed to the scanning and processing engine as shown. In the alternative, and as indicated by the dotted portion, the query processing engine 405 may simply reject the query operation entirely, e.g., if the querier is requesting more access than they would otherwise properly be granted by the configured policy or policy. FIG. 5 illustrates a second use case, wherein the query 500 does not included any specified data-centric labels. In this example, once again the query processing engine 505 calls out to the security policy engine, which in turn evaluates the one or more configured policies to return the appropriate set of data-centric labels. In this scenario, in effect the querier is stating it wants all of his or her entitled data-centric labels (e.g., labels L1-L6) to be applied to the query; if this is permitted, the query includes these labels and is once again passed to the scanning and processing engine.

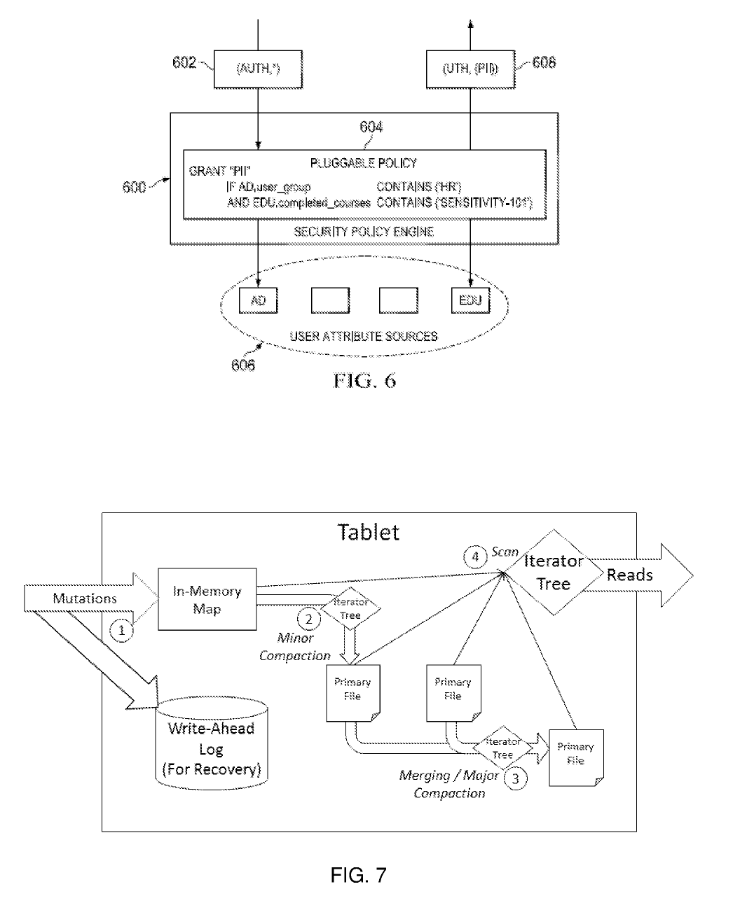

FIG. 6 illustrates the basic operation of the security policy engine. In this example, the query 602 does not specify any data-centric labels. The security policy engine 600 includes at least one pluggable security policy 604 that is configured or defined, as will be explained in more detail below. In general, a pluggable policy takes, as input, user-centric attributes (associated with a user-centric realm), and applies one or more policy rules to generate an output in the form of one or more data-centric attributes (associated with a data-centric realm). As noted above, this translation of user-centric attribute(s) to data-centric label(s) may involve the security policy engine checking values of one or more user attribute sources 606. Generalizing, a “user-centric” attribute typically corresponds to a characteristic of a subject, namely, the entity that is requesting to perform an operation on an object. Typical user-centric attributes are such attributes as name, data of birth, home address, training record, job function, etc. An attribute refers to any single token. “Data-centric” attributes are associated with a data element (typically, a cell, or collection of cells). A “label” is an expression of one or more data-centric attributes that is used to tag a cell.

In FIG. 6, the pluggable policy 604 enforces a rule that grants access to the data-centric label “PII” if two conditions are met for a given user: (1) the user's Active Directory (AD) group is specified as “HR” (Human Resources) and, (2) the user's completed courses in an education database EDU indicate that he or she has passed a sensitivity training class. Of course, this is just a representative policy for descriptive purposes. During the query processing, the policy engine queries those attribute sources (which may be local or external) and makes (in this example) the positive determination for this user that he or she meets those qualifications (in other words, that the policy rule evaluates true). As a result, the security policy engine 600 grants the PII label. The data-centric label is then included in the query 608, which is now modified from the original query 602. If the user does not meet this particular policy rule, the query would not include this particular data-centric label.

The security policy engine may implement one or more pluggable policies, and each such policy may include one or more policy rules. The particular manner in which the policy rules are evaluated within a particular policy, and/or the particular order or sequence of evaluating multiple policies may be varied and is not a limitation. Typically, these considerations are based on the enterprise's information security policies. Within a particular rule, there may be a one-to-one or one-to-many correspondence between a user-centric attribute, on the one hand, and a data-centric label, on the other. The particular translation from user-centric realm to data-centric realm provided by the policy rule in a policy will depend on implementation.

### Document-Partitioned Secondary Indexes

As described above, the techniques herein are implemented in a sorted key/value store, namely, a mechanism that associates keys with values, provides an interface for inserting keys with their associated values (in any order), and provides an efficient interface for retrieving ranges of keys and their associated values in sorted order. The set of key/value pairs that are directly accessed through the API of a sorted key/value store is also sometimes referred to as a primary store. Within this context, a table is a collection of sorted key/value pairs that is accessed and managed independently, and a tablet is a partition of a table that contains all of the key value pairs in a given sub-range of keys. Accumulo is a sorted key/value store built on top of Apache Hadoop and that provides these characteristics, as has been described. In a typical implementation, Accumulo manages tables, distributing and hosting their tablets throughout a cluster of tablet servers. A tablet server typically is implemented in software that executes on a computing machine. Accumulo's application programming interface (API) supports ingest of key/value pairs, grouped into atomically applied objects known as Mutations, using a mechanism known as the BatchWriter. Accumulo also supports streaming ranges of key/value pairs back to client applications using a mechanism known as a Scanner, which has a batched variant called the BatchScanner. Using these mechanisms, Accumulo supports efficient ingest and query of information as long as the queries are aligned with the keys' sort order.

To support queries that are not aligned with the primary sort order, applications built on Accumulo either must rely (i) on table scans to do a brute force evaluation of the queries, or (ii) leverage an index and perform a secondary lookup in the Accumulo table(s). Indexed lookup has a long history, predating even modern computational theory. That said, many advances have been made in information retrieval in the last two decades. One of these advances is related to use of so-called “secondary indexes.” A secondary index is a collection of information that is used to optimize particular types of search and query against the sorted key/value (the primary) store. It is known to store a secondary index in a way that is co-partitioned with the data to which the index entries refer. This technique is known as document-distributed indexing, or indexing sharding. A document-distributed index (or co-partitioned index) is a secondary index in which each index entry, which refers to an object in the primary store, is kept in the same partition (i.e., tablet) as the object to which it refers. Document-distributed indexing has many benefits over other techniques, including its ability to leverage the hardware parallelism supported by clusters of processors, its ability to perform index joins in a distributed fashion, and its resistance to hot spots, in which many queries require concurrent access to a small subset of computing resources.

Document-distributed information retrieval requires that secondary index entries are co-partitioned with the primary store entries to which they refer. This allows for a local lookup of the primary store entry after retrieving an index entry, and it also guarantees that two secondary index entries that would be joined in support of a complex query are kept in the same partition as each other.

In Accumulo's case, co-partitioning secondary index entries means that partitions of the secondary index must follow the tablets in the primary store and be co-hosted on the same compute resources.

With the above as background, the techniques of this disclosure are now described. As will be seen, these techniques provide for a set of mechanisms to create, store, maintain, and query secondary indexes within an automatically partitioned log-structure merge tree leveraged by a sorted key-value store database. By way of example only, the detailed discussion below is based on tracking the lifecycle of Accumulo tablets and automating actions on secondary indexes so that they preserve the co-partitioning property. This approach is not limited to Accumulo, and it can be extended to any database with a design based on the Google BigTable architecture.

FIG. 7 illustrates a lifecycle of a tablet, which as noted above represents a partition of a table (a collection of key/value pairs). More generally, a tablet is a unit of work for a tablet server executing in a machine. As illustrated, the lifecycle of a tablet 700 includes a set of activities. The ordering of these activities is not intended to be limiting.

Typically, and at activity (1), referred to as creation, the tablet 700 is created, typically at the time a table is created. The tablet may start with an unbounded key range, or it may have been “pre-split” and start with a bounded key range. The notion of a “split” refers to an operation in which a tablet, represented by a key range, is divided into two tablets. The key ranges of the two resulting tablets have an empty intersection and their union is the range of the original tablet. Thus, all key/value pairs from the original tablet are migrated into exactly one of the resulting tablets.

At activity (2), an ingest activity occurs. At ingest, a key/value entry in the primary store of a table is ingested into a tablet, typically as part of a mutation 702 that is received through an API call. The mutation is first written to a write-ahead log 704 that is associated with that tablet, and then inserted into an in-memory write buffer 706 (shown as in-memory map). As soon as it is in the write buffer, the mutation is available for query.

A minor compaction, activity (3), is an operation in which the in-memory write buffer 706 containing key value entries or index entries is written into a file on disk, which then replaces the in-memory write buffer as a source of data for query. When the write buffer fills, a minor compaction is triggered. As noted, the minor compaction flushes the write buffer to a sorted file; the write buffer is then swapped for the sorted file as a source for queries, and a new write buffer takes its place to support future ingest.

A major compaction, activity (4), is an operation in which multiple files containing key/value entries or index entries are merged together to form a single new file, which then replaces the original files. Major compaction merges one or more individually sorted files together to form a new file, and it is necessary to maintain optimized range query performance on the primary store.

A scan, activity (5), is an operation responsive to an API call, and it scans merge data gathered from any active files and write buffers to provide a query response. A scan may take advantage of a locality group, which is a collection of columns that are stored together in a separate partition from other columns. Locality groups support faster scans over a subset of the columns by increasing the density of desired columns in blocks that are read in support of a query.

A split, activity (6), is an operation in which a tablet, represented by a key range, is divided into two tablets. When tables grow beyond a specified size, they are split to form two resulting tablets. During the split, a median key is chosen, the original tablet's write buffer is flushed as a minor compaction, and the tablet is taken offline. Two new tablets are created with the original key range partitioned by the median key, the file references of the original tablet are copied into the two new tablets, and the two new tablets are brought online. After a split, scans and compactions over the inherited files are limited to the key range of the tablet being scanned to avoid duplicating data.

A merge, activity (7), which also is an operation responsive to an API call, is an activity wherein two or more tablets with contiguous key ranges may be merged together to form a new tablet. In particular, a merge operation comprises chopping the files associated with each tablet (compacting them to remove any reference to keys outside of the tablet's key range), taking the tablets offline, creating a new tablet whose key range is the union of all of the input tablets, copying all of the file references from all of the input tablets into the new tablet, and bringing the new tablet online.

Thus, a merge and a split are opposite operations. A merge provides a way for two or more tablets whose key ranges abut are joined into one tablet, and a split provides a way for dividing a tablet represented by a key range into two tablets.

A deletion, activity (8), is an activity that deletes the tablet, typically when the table that contains it is deleted as a result of an API call. This operation involves taking the tablet offline and cleaning up all of the files and other resources referenced by the tablet.

FIG. 7 also illustrates several iterator trees. An iterator is a mechanism that is used during compaction and query operations to transform source data into results. Iterators provide an interface that supports seeking to a range and iterating through the elements in that range. Iterators are modular operators, and they typically leverage other iterators as sources.

In general, ordinary tablet data flow involves several high level operations. Mutations are written to the write-ahead log (for durability/recovery) and inserted into an in-memory map, at which time the insert is acknowledge to the client. When the in-memory map is selected for minor compaction it is written in a single stream as an immutable file, which then replaces the in-memory map as a query source. As a background operation, major compactions merge together multiple files into a single resulting file to improve query efficiency. After a major compaction the resulting file replaces the input files as a query source. Scans of the tablet merge together all active query sources (in-memory map plus a collection of files) to provide a single sorted stream of key/value pairs.

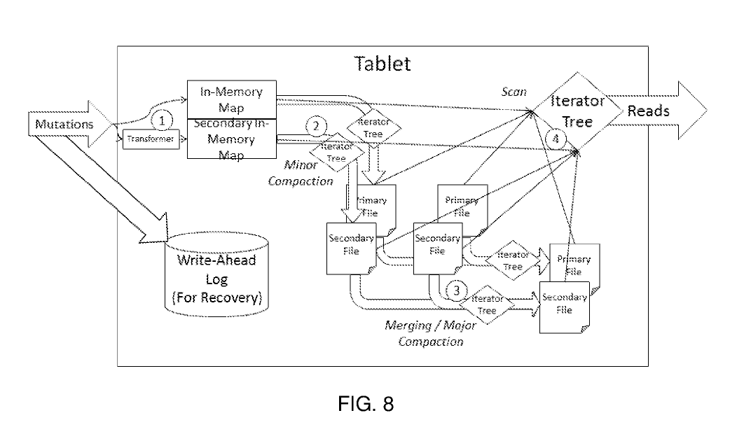

According to this disclosure, secondary indexes are adapted for efficient inclusion in all of the tablet lifecycle activities. Typically, each lifecycle activity is as described above with respect to FIG. 7 but also includes additional (augmented) features to facilitate the secondary index structures and to maintain the co-partitioning of the secondary index. FIG. 8 illustrates these modified tablet lifecycle activities, which are now described.

At creation, activity (1), any resources needed to maintain the secondary index structures for the tablet are also created.

At ingest, activity (2), a mechanism to translate a mutation into a collection of secondary index entries is provided. This mechanism is referred to as a “transformer.” This nomenclature is not intended to be limited. Typically, a transformer extracts values from entries in a mutation and generates index entries by inverting them, mapping the value back to the primary store key. The index entries generated by the transformer are then committed to an in-memory write buffer associated with the secondary index for that tablet. Preferably, secondary index entries are not written to the tablet's write-ahead log, as they can be recovered from the primary store mutations. For different types of indexes (e.g. geospatial or graph index), the transformer creates different types of index entries. Preferably, the index entries are all committed to the secondary index at the same time that the mutation is contributed to the primary store so as to maintain atomicity and isolation properties in the index. In the case that ingest of a mutation into the primary store is an update to previously written key/value entries, the operation may trigger a modification to the previously generated index entries. This is done to maintain referential integrity in the secondary index.

Minor compaction, activity (3), also is modified to facilitate the secondary index support. In particular, when the primary store for a tablet goes through a minor compaction, a minor compaction is triggered for each secondary store. As the primary store is transitioned from reading the write buffer to reading the newly generated file, the secondary indexes are synchronously (atomically) transitioned to use their minor compacted files. The atomic transition for all minor compactions is required to maintain failure recovery without writing secondary indexes to the write-ahead log. Minor compaction of secondary indexes requires that the data structure for the secondary index support an efficient serialization to an on-disk format that supports efficient query.

Major compaction, activity (4), also is modified to facilitate the secondary index support. In particular, files associated with each secondary index are major compacted independently of the primary store and of each other. The purpose of major compaction of the secondary index files is the same as for the primary store, namely, increasing index storage and query efficiency. Preferably, a watcher thread that uses a pluggable file selection algorithm triggers the major compaction of secondary index files. The optimal criteria for when to compact and which files to compact vary by index type.

The scan, activity (5), provides access to secondary indexes at scan time. This access is provided to iterators via an environment object. It is left up to the iterator regarding how to best leverage the secondary index, including implementation of index joins and secondary lookups of data in the primary store.

During a split, activity (6), all file references from the original tablet are copied to the resulting tablets without copying the files. These include both file references for the primary store and for the secondary indexes. After a split, a pluggable filter function is applied to all accesses of the secondary index files that were created before the split. The filter eliminates secondary index entries that are associated with primary store entries outside of the tablet (i.e. in the other tablet resulting from the split). This filter also applies during accesses within major compactions. The filter function is specified at the time that the secondary index is created.

Just as in merging the primary store, the merge activity (7) involves chopping the secondary index files and then associating them with the merged tablet.

Finally, in a deletion, activity (8), all resources allocated to the secondary index are cleaned up as the tablet is deleted.

In general, the modified tablet data flow to support secondary indexes involves several high level operations. As mutations are added to the tablet server they are passed to a transformer to extract index entries. The results of the transformer and the original mutation are applied to their respective in-memory maps as an atomic and isolated operation. When a minor compaction is triggered (often due to memory pressure) the primary in-memory map and secondary in-memory maps are flushed to disk as an atomic, isolated operation. Maintenance operations on the secondary indexes are performed as needed by another set of resources that is shared with the major compaction operations on the primary store. Access to the secondary indexes is provided to the scan-time iterators via an environment object.

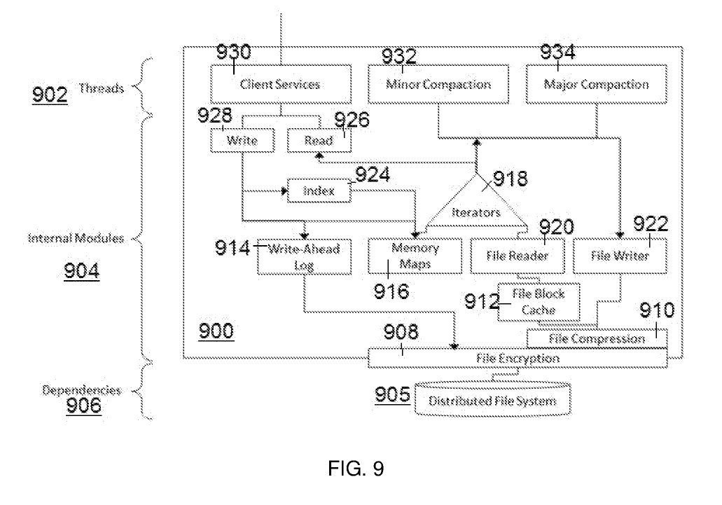

FIG. 9 illustrates the tablet server that is augmented to provide the secondary index support. The tablet server 900 comprises threads 902 and internal modules 904, which overlay a dependencies layer 906. The dependencies are the distributed file system 905. The internal modules typically comprise a number of low level operations such as file encryption 908, file compression 910, and file block caching 912. The internal modules 904 also includes the write-ahead log 914, memory maps 916 and iterators 918 previously described. Additional modules include a file reader 920, a file writer 922, an index module 924, a read module 926, and a write module 928. The threads layer comprises client services 930, minor compaction 932, and major compaction 934. One or more of these modules may be combined or integrated with one another.

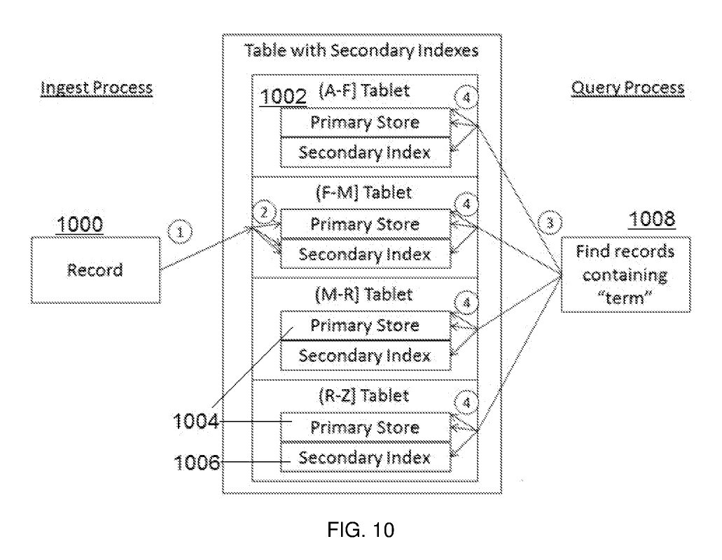

FIG. 10 illustrates a document-partitioned index according to this disclosure. As illustrated, and at step (1), a record 1000 is sent to an appropriate tablet 1002 according to some partitioning algorithm, generally by range-partitioning and/or hashing an identifier (ID) for the record. Locally on the tablet server, a transformer generates secondary index entries for the record. At step (2), the record is inserted into the primary store 1004, and its associated secondary index entries are inserted into the secondary indexes 1006 as an atomic, consistent, isolated, and durable operation. Subsequently, at step (3), a query 1008 for a given term or expression of query logic is distributed to all partitions that may contain records for that query. At step (4), each tablet processes the query by joining relevant secondary index entries with each other and looking up the records in the local primary store.

In the described approach, preferably the secondary indexes are maintained by merging multiple files where necessary. Splitting typically involves child tablets referencing the same index files as the parent tablet, with the child tablets then filtered at query time.

Preferably, several additional techniques are implemented to ensure that secondary index entries remain co-partitioned with the primary entries to which they refer throughout the lifecycle of a tablet that has been augmented to support them. These include one of more of the following: (i) pre-splitting of secondary indexes in anticipation of a table split, (ii) the prioritizing of major compaction of secondary index files after a split operation, (iii) enforcing the use on the secondary index entries of the same security labels as the entries in the primary store from which the secondary index entries were generated, (iv) synchronizing minor compactions of primary store and secondary index store to guarantee atomicity and isolation of writes and reads across all stores in the tablet, (v) reconstructing secondary index entries from the primary entries in the write-ahead log at recovery time (instead of writing the secondary index entries to the write-ahead log), (vi) exposing queries to the secondary indexes as iterators within the iterator tree, (vii) combining multiple secondary indexes and the primary index (e.g., unions and intersections of index entries, hash joins, sort-merge joins, nested loop joins, and lookup joins) to produce a query result in response to a Boolean logic query; (viii) enabling the secondary indexes and the primary store to share an LRU-based read cache; (ix) supporting columnar partitioning on the secondary index, e.g., via locality groups; (x) storing in the secondary index cell-level security labels, wherein the secondary index readers filter index entries using the same cell-level security filter used in the primary store; (xi) preserving the same cell-level security labeling from the original mutations; (xii) supporting compaction-time and scan-time iterators similar to the primary store; (xiii) supporting bulk loading of information into secondary indexes, e.g., by specification of files in a native format of the type of index, where preferably each bulk-loaded file is associated with the primary store key range and is then loaded into all existing tablets that overlap the specified key range; (xiv) populating a secondary index with a bulk transformation of existing primary store entries; and (xv) automatically maintaining referential integrity of secondary index entries by propagating changes in the primary store so as to remove secondary index entries, and by re-generating a secondary index from the primary store as a bulk transformation, preferably scheduled periodically or as a one-time operation.

In the described approach, preferably the secondary indexes are maintained by merging multiple files where necessary. Splitting typically involves child tablets referencing the same index files as the parent tablet, which are then filtered at query time.

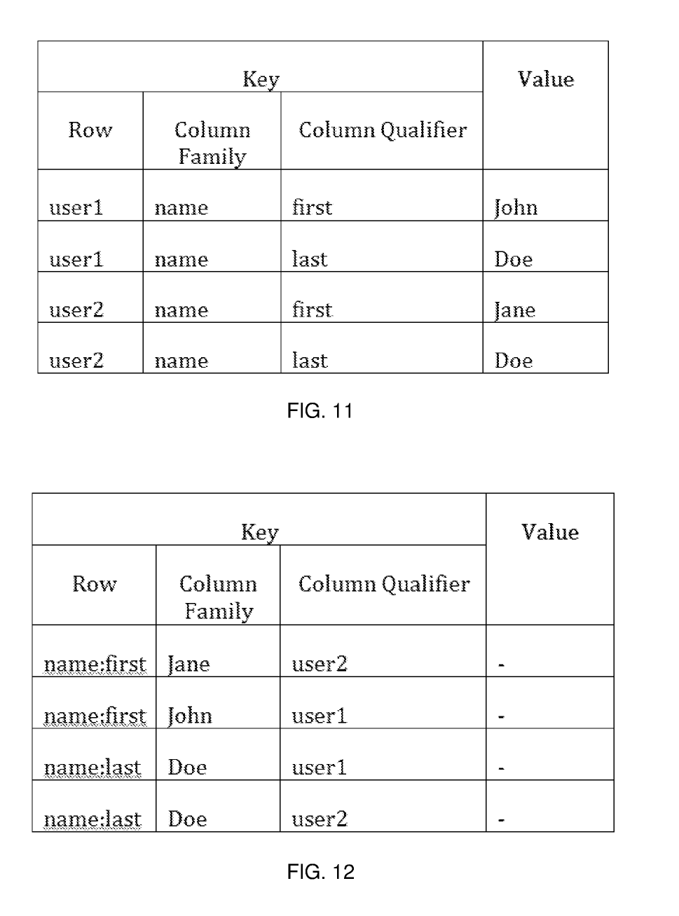

The following provides an example scenario illustrating the use of document-partitioned secondary indexes in a sorted, distributed automatically partitioned key/value data store according to this disclosure. FIG. 11 illustrates a primary store with a set of key/values. As is well-known, this data may be transformed into inverted index entries to facilitate finding rows in the primary store with particular values. The result is illustrated in FIG. 12. With an inverted index such as shown in FIG. 12, a query can be performed for all records with a first name of “John,” namely, by scanning a contiguous range of the index and pulling the record IDs out of the column qualifier. The record IDs can then be used to look up fill records in the primary store as one contiguous range per record.

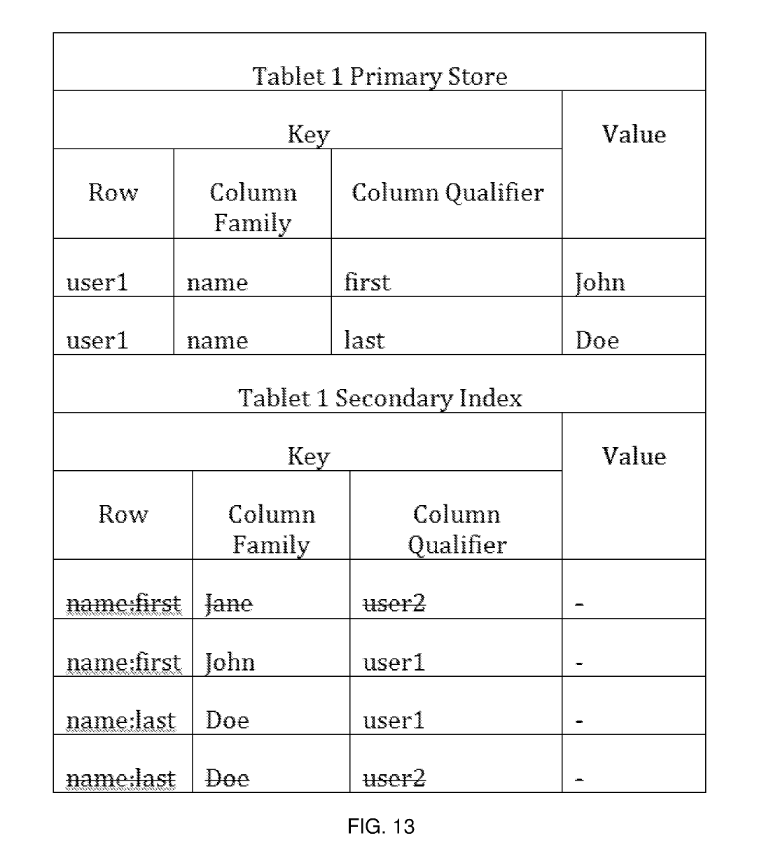

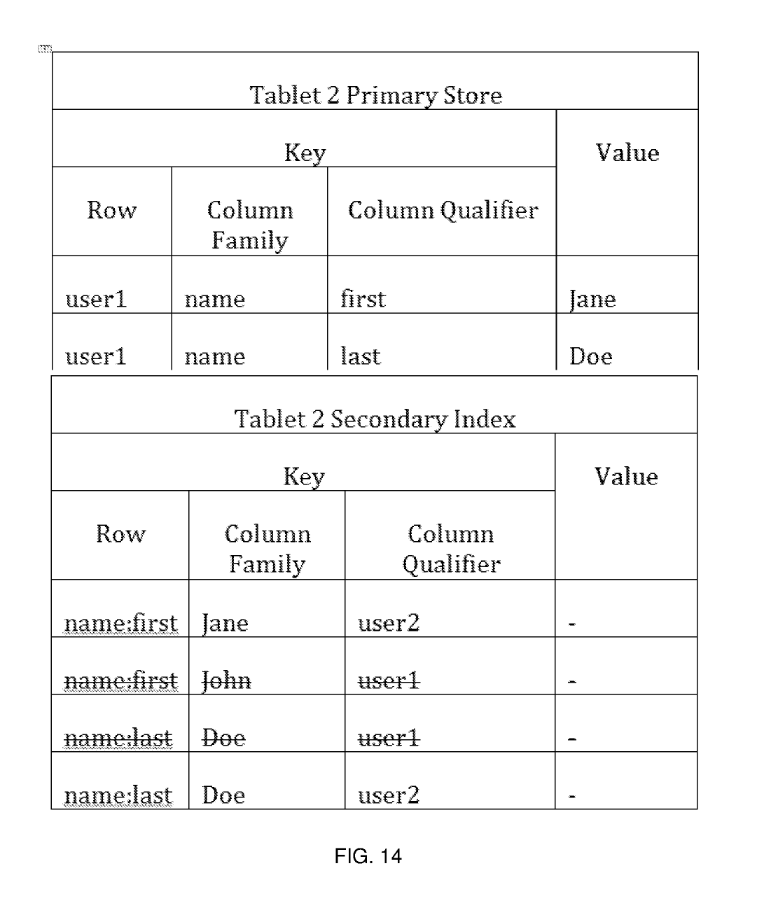

If, however, the tablet containing the above records grows too large, the tablet may be split, e.g., by choosing a median row key, say “user1.” Secondary indexes may then be introduced. The result of the split is shown in FIG. 13 and FIG. 14. The split operation preferably results in one tablet logically containing entries for user1, and the other tablet logically containing entries for user2. As illustrated, and after the split, the indexes are duplicated between the two tablets and then filtered to provide a logical view containing only the index entries pertaining to the local tablet. This filtering is depicted using the strikethrough. Thus, according to this approach, the co-partitioning of secondary index entries provides that partitions of the secondary index follow the tablets in the primary store and preferably are hosted on the same compute resources. In other words, using this technique, the index entries are guaranteed to be co-partitioned with the primary store tablets, ensuring correctness of the index.

Typically, and due to the importance of index performance, an additional optimization step of compacting indexes is implemented. Generalizing, after a split major compaction of indexes is prioritized. In the major compaction, preferably the filtered index entries are omitted as a new, optimized index is created.

While the above example depicts an inverted index, this is not intended as a limitation, and there are many different types of indexes that might be stored within this framework. Thus, for example, for unstructured data or human language data, a full text index with language analyzers to transform text blobs into index entries may be used. For geospatial or geo-temporal data, one might index points, polygons, and other shapes in a multi-dimensional space.

Secondary indexes may be implemented in any convenient manner using a variety of different data structures. Preferably, such indexes are optimized for numerous factors, including, without limitation, cost of maintenance, cost of writes, storage footprint and efficiency of query. For a traditional inverted index, a B-Tree data structure might be used, while for a multi-dimensional (e.g. geo-temporal) index an R*Tree might be used. Generalizing, for any given data structure, typically two operations are required: (1) support for merging file representations of the data structure, and (2) support for filtering based on primary key ranges. With these restrictions data structures may fit naturally (e.g. B-Trees have natural definitions for merging and filtering), they may require modifications or new algorithms (e.g. RTrees require an algorithm to efficiently merge while maintaining index efficiency), or they may require brute force reconstruction to handle a split or a compaction (e.g. Bloom filters don't contain a primary store ID, so they cannot be filtered after a split; instead they must be rebuilt to maintain index efficiency). For indexes (such as B-trees) that naturally serialize into sorted files, the merging and filtering operations are naturally defined. In particular, the merge operation is a sort-merge join, and scans of the index are filtered by checking the referenced record ID against the tablet key range.

For multi-dimensional tree index data structures, filtering is generally done by evaluating the referenced IDs against the tablet key range, as in the case with sorted indexes. Merging, however, is often more complex in order to maintain index query efficiency. Algorithms to merge multi-dimensional index data structures can be defined on a case-by-case basis.

Indexes that either do not contain references to record IDs, such as Bloom filters, or are otherwise complicated to merge, such as open address hash tables, can be rebuilt from scratch after a split operation and are generally not merged in a background major compaction operation.

Thus, according to this disclosure, the secondary index is one of: a full-text inverted index, a geospatial index (e.g., z-order or Hilbert curve), a geohash, a quad tree, an R-tree, a k-d tree, a BSP tree, a grid index, and a graph index (e.g., that maps remote vertexes to vertexes stored in the local tablet's primary store). The secondary index preferably is a sorted key/value store leveraging a data structure, such as B-tree, an ISAM file, or other sorted key/value file formats.

Accumulo and related databases support a mechanism of bulk loading of data in the form of native primary store files. To address secondary indexing of bulk loaded data preferably two mechanisms are included. The first is to support bulk loading secondary index files, and the second is to support batch generation of secondary index entries from a selection of entries in the primary store as a background operation. For the former, the system allows the user to specify a primary store key range associated with each file to be bulk loaded into the secondary index. This range is then used to identify into which tablets the secondary index file should be loaded. For background generation of secondary indexes, the system allows the user to execute an index maintenance task that processes a specified subset of primary store entries over a range of tablets.

The techniques herein provide many advantages. The approach supports secondary indexing in a key value/data store (including, without limitation, Accumulo) that aligns with tablet partitioning (document-distributed indexing). The approach automatically aligns secondary indexing with tablet partitioning. The approach provides supports for automatic splitting of large tablets, and facilitates the use of simple data schemas. An information retrieval system that leverages the described secondary indexing techniques can use a query processor to find and retrieve documents matching a user's query.

As has been described, the approach advantageously provides a way to extend an index data structure with filter and merge operations, where the index can be serialized in a one-dimensional sort order to include B-trees, binary search trees, splay trees, consistent hash maps, space filling curve indexes, grid indexes, skip lists, tries, etc. The approach to extending index data structure also applies to multi-dimensional indexes, such as R-Trees, quad-trees, k-d trees, BSP trees, and the like. Various extensions are also contemplated. Thus, the approach may apply to single- or multiply-linked lists, as well as to machine learning structures, such as random forests, neural nets, Markov chains, matrixes, and the like.

The above-described architecture may be applied in many different types of use cases. General (non-industry specific) use cases include making Hadoop real-time, and supporting interactive Big Data applications. Other types of real-time applications that may use this architecture include, without limitation, cybersecurity applications, healthcare applications, smart grid applications, and many others.

As also noted, the approach herein is not limited to use with Accumulo; the security extensions (role-based and attribute-based access controls derived from information policy) may be integrated with other NoSQL database platforms. NoSQL databases store information that is keyed, potentially hierarchically. The techniques herein are useful with any NoSQL databases that also store labels with the data and provide access controls that check those labels.

Each above-described process preferably is implemented in computer software as a set of program instructions executable in one or more processors, as a special-purpose machine.

Representative machines on which the subject matter herein is provided may be Intel Pentium-based computers running a Linux or Linux-variant operating system and one or more applications to carry out the described functionality. One or more of the processes described above are implemented as computer programs, namely, as a set of computer instructions, for performing the functionality described.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be a particular machine that is specially constructed for the required purposes, or it may comprise a computer otherwise selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. The functionality may be built into the name server code, or it may be executed as an adjunct to that code. A machine implementing the techniques herein comprises a processor, computer memory holding instructions that are executed by the processor to perform the above-described methods.

While given components of the system have been described separately, one of ordinary skill will appreciate that some of the functions may be combined or shared in given instructions, program sequences, code portions, and the like.

Preferably, the functionality is implemented in an application layer solution, although this is not a limitation, as portions of the identified functions may be built into an operating system or the like.

The functionality may be implemented with any application layer protocols, or any other protocol having similar operating characteristics.

There is no limitation on the type of computing entity that may implement the client-side or server-side of the connection. Any computing entity (system, machine, device, program, process, utility, or the like) may act as the client or the server.

While given components of the system have been described separately, one of ordinary skill will appreciate that some of the functions may be combined or shared in given instructions, program sequences, code portions, and the like. Any application or functionality described herein may be implemented as native code, by providing hooks into another application, by facilitating use of the mechanism as a plug-in, by linking to the mechanism, and the like.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

The platform functionality may be co-located or various parts/components may be separately and run as distinct functions, in one or more locations (over a distributed network).

Another variant is a machine learning system that leverages the above-described secondary indexing and query processing, e.g., with inverted indexes, statistical indexes, graph indexes, and/or multi-dimensional indexes, to perform data analysis.

The techniques herein generally provide for the above-described improvements to a technology or technical field (namely, key/value data storage), as well as the specific technological improvements to other industrial/technological processes (e.g., cybersecurity applications, healthcare applications, smart grid applications, interactive Big Data applications, and many others) that utilize such information storage and retrieval mechanisms, such as described above.

What is claimed is as follows:

1. A method operative in association with a table in a sorted, distributed key-value primary store, the table having associated therewith one or more tablets, each tablet being a partition of the table and that contains key-value pairs in a given sub-range of keys, the method comprising:
generating a secondary index adapted to optimize particular search and query operations against the primary store;
storing the secondary index such that secondary index entries are co-partitioned with entries of the primary store to which the secondary index entries refer; and
maintaining co-partitioning of the secondary index throughout a lifecycle of at least one tablet.

2. The method as described in claim 1 wherein the lifecycle of the tablet includes a set of activities that include one of: creation, ingest, minor compaction, major compaction, scan, split, merge and deletion.

3. The method as described in claim 2 wherein, during ingest, the step of storing the secondary index such that secondary index entries are co-partitioned includes extracting one or more values of a table object and processing the extracted values according to an index type to form the entries for the secondary index.

4. The method as described in claim 3 wherein the index type is one of: a full-text inverted index, a geospatial index, a geo-hash, a quad tree, an R-tree, a k-d tree, a BSP tree, a grid index, and a graph index.

5. The method as described in claim 2 wherein the minor compaction of the tablet is carried out when the primary store itself undergoes a minor compaction.

6. The method as described in claim 2 wherein the major compaction of the tablet is carried out independently of any major compaction associated with the primary store.

7. The method as described in claim 2 wherein, during a split, all file references for the primary store and the secondary index are copied from the at least one tablet to two new tablets.

8. The method as described in claim 2 wherein, during a merge, one or more files associated with a secondary index from at least two other tablets whose key ranges about one another are joined into the at least one table.

9. Apparatus, operative in association with a table in a sorted, distributed key-value primary store, the table having associated therewith one or more tablets, each tablet being a partition of the table and that contains key-value pairs in a given sub-range of keys, comprising:
one or more hardware processors;
computer memory storing computer program instructions executed by the hardware processors to:
generate a secondary index adapted to optimize particular search and query operations against the primary store;
store the secondary index such that secondary index entries are co-partitioned with entries of the primary store to which the secondary index entries refer; and
maintain co-partitioning of the secondary index throughout a lifecycle of at least one tablet.

10. The apparatus as described in claim 9 wherein the lifecycle of the tablet includes a set of activities that include one of: creation, ingest, minor compaction, major compaction, scan, split, merge and deletion.

11. The apparatus as described in claim 9 wherein the computer program instructions further include computer program instructions operative at query time and in response to receipt of a query to:
use the secondary index to search against the primary store; and
to return a response to the query.

12. The apparatus as described in claim 8 wherein the sorted, distributed key-value primary store is Accumulo.

13. The method as described in claim 1 wherein the secondary index entries remain co-partitioned with the primary entries to which they refer throughout the lifecycle of a tablet by one or more: (i) pre-splitting of secondary indexes in anticipation of a table split, (ii) prioritizing of major compaction of secondary index files after a split operation, (iii) enforcing use on the secondary index entries of same security labels as the entries in the primary store from which the secondary index entries were generated, (iv) synchronizing minor compactions of primary store and secondary index store to guarantee atomicity and isolation of writes and reads across all stores in the tablet, (v) reconstructing secondary index entries from the primary entries in the write-ahead log at recovery time, (vi) exposing queries to the secondary index as an iterator within an iterator tree, (vii) combining multiple secondary indexes and the primary index to produce a query result in response to a Boolean logic query; (viii) enabling the secondary indexes and the primary store to share an LRU-based read cache; (ix) supporting columnar partitioning on the secondary index; (x) storing in the secondary index cell-level security labels, wherein the secondary index readers filter index entries using the same cell-level security filter used in the primary store; (xi) preserving the same cell-level security labeling from the original mutations; (xii) supporting compaction-time and scan-time iterators similar to the primary store; (xiii) supporting bulk loading of information into secondary indexes; (xiv) populating a secondary index with a bulk transformation of existing primary store entries; and (xv) automatically maintaining referential integrity of secondary index entries by propagating changes in the primary store so as to remove secondary index entries, and by re-generating a secondary index from the primary store as a bulk transformation, preferably scheduled periodically or as a one-time operation.
